(19) United States
(12) Patent Application Publication
(10) Pub. No.: US 2003/0230012 A1
(43) Pub. Date: Dec. 18, 2003

(54) Card with three dimensional (3-D) pop-up box

(76) Inventor: Mordeckai Mouyal, Tel Aviv (IL)

Correspondence Address: B-Moss USA, Inc., c/o Dimitri Pressman, 4th Floor, 379 Fifth Avenue, New York, NY, 10016, US

(21) Appl. No.: 10/167,597

(22) Filed: Jun. 12, 2002

(51) Int. Cl. G09F 1/00

(52) U.S. Cl. 40/124.08

(57) ABSTRACT

The card with three-dimensional (3-D) pop-up box is made up of two pieces of foldable cardstock or other planar material (the Card and the Pop-up Box, respectively), which Card and Pop-up Box are folded and attached in such a way that, when the Card is folded along a vertical crease, the Pop-up Box lies flat between the left and right hand panels of the Card, and when the Card is unfolded the Pop-up Box “pops-up” to form of a three dimensional box. Said card with 3-D pop-up box is distinct from, and an improvement upon, other pop-up devices in a number of regards: the pop-up mechanism is self-propelling, such that merely opening the card causes the Pop-up Box to pop-up; the pop-up mechanism is made from only two sheets of cardstock or other planar material, and as such is both time and cost effective to assemble and distribute; the pop-up mechanism forms a three dimensional box when erect, which box enables the sender to display a replica or prototype of any box-shaped object, for example a box of medicine, a pack of cigarettes, an office building or any other box-shaped object; which box also enables the sender to place a message or advertisement that can be viewed from 360 degrees and from the top when the card is opened.

### BACKGROUND OF THE INVENTION

1. Field of the Invention

The subject invention relates to the field of pop-up cards and, more particularly, to a pop-up card of the type in which the pop-up portion forms a three-dimensional box when erect.

The subject invention also relates to the field of advertising and promotional techniques and, more particularly, to an advertising and/or promotional piece that includes a pop-up feature.

2. Description of the Related Art

No matter the location, the consuming public is inundated with promotional material from every type of commercial enterprise, in the form of business cards, T-shirts, hats and many other objects. In particular, the consuming public is inundated with paper advertisements in the form of newspaper inserts, catalogs, flyers, postcards, coupon books and the like. Due to these factors, advertisers are continually searching for new and more effective promotional materials with which they can gain the attention of consumers. Prior attempts to gain the attention of consumers, both in the form of paper advertisements and more generally in the form of promotional materials, have included colorful artwork, controversial slogans, eye-catching shapes, contests, coupons and novel means with which to deliver the above to the consumer. Though these methods of gaining the attention of consumers have been and continue to be successful to a certain extent, there exists a constant need on the part of companies and individuals to deliver their advertising and promotional materials in novel, attention-getting ways.

Additionally, advertisements and promotional materials must reach numerous consumers in a cost-efficient manner. Thus, the most favorable promotional materials cards should be simply and quickly mass manufactured and should employ inexpensive materials.

Addressing the above problems, inventors have created the field of pop-up devices, and the more particular field of pop-up cards. [For example, see U.S. Pat. Nos. 4,103,444 (Flap pop-up for advertising leaflets), 5,450,680 (Pop-up card and method of making same), 6,036,806 (Pop-up advertising device and method), 6,192,608 (Pop-up advertising piece)]. Pop-up cards peak consumer interest through the incorporation of dynamic parts. Furthermore, the possibility of displaying objects elevated or erect from the flat plane of the card enables the sender to better convey the form and shape of various objects for the benefit of the receiver. Pop-up cards are versatile, as they can be distributed in many different forms and through numerous distribution channels, including as inserts in newspapers and magazines, as mailers, as a “give-away” packaged with related products or in person by salesmen at trade shows and meetings. Moreover, pop-up cards can be made from paperboard and delivered as flat cards, thereby reducing cost of manufacture and risk of damage to said cards during delivery.

Advertisers have for the most part relied upon two-dimensional (i.e. flat) representations of three-dimensional objects, either contained in the flat plane of the advertisement in the form of a photograph, drawing or the like, or standing erect, perpendicular to the flat plain of the card, as pop-ups. However, advertisers sometime desire to provide truly three-dimensional displays for the purpose of peaking consumer interest, and sometime desire to deliver fully three-dimensional replicas of various products to the consumer, while maintaining the efficient cost structure of a paperboard card. Moreover, advertisers are always looking for innovative ways with which to deliver their messages, particularly in eye-catching ways, as the modern consumer becomes dismissive and disinterested with the familiar, and particularly with that which is static.

### BRIEF SUMMARY OF THE INVENTION

It is a general object of the present invention to provide an improved pop-up card; it is a more particular object of the present invention to provide a novel pop-up card with three-dimensional “pop-up box.”

It is a further general object of the present invention to provide a novel device for displaying and delivering paperboard replicas; it is a more particular object of the present invention to provide a novel device for displaying and delivering paper-board replicas of three-dimensional objects; it is a more particular object of the present invention to provide a novel device for displaying and delivering paper-board replicas of three-dimensional objects of a box-like shape.

Addressing the evolving needs of advertisers and other purveyors of information, the card with 3-D pop-up box attracts and holds the attention of recipients through its novel pop-up mechanism and its ability to display fully three-dimensional objects when the card is open while collapsing between the panels of the card when the card is closed.

Moreover, addressing the limitations of other pop-up mailers, the card with 3-D pop-up box pops-up into a fully three-dimensional form, in the shape of a box, such that the sender can produce three-dimensional replicas for use in promotional material and other purposes of any box-shaped object, in actual size (for example a pack of cigarettes), as a to-scale replica (for example a fish tank) or in any other way. The advertiser or other sender is thus able to mass-produce and distribute three-dimensional prototypes in a novel, attention-getting, durable, cost-effective and easily produced manner. An additional improvement of the card with 3-D pop-up box is that the advertiser or other sender is able to place a message or advertisement that can be viewed from 360 degrees and from the top when the card is opened, maximizing visual appeal and advertising space (the Pop-Up Box portion of the card has a far greater surface area than a comparable two-dimensional pop-up mailer).

### BRIEF DESCRIPTION OF THE SEVERAL VIEWS OF THE DRAWING

FIG. 1 Internal view of the opened up Base prior to the attachment of the 3-D Pop-up Box

FIG. 2 Overview of the unassembled Pop-up Box

FIG. 3 View of the unassembled Pop-up Box set in position to be assembled and inserted into the Base

FIG. 4 View of the partially assembled Pop-up Box according to FIG. 3 with 3 of its Flaps being folded into proper position

FIG. 5 View of the partially assembled Pop-up Box according to FIG. 4 with the Box Top and its three Flaps being folded over the Slide Member

FIG. 6 View of the assembled Pop-up Box, before attachment to the Base

FIG. 7 View of the process by which the Slide Member is pushed and the Pop-up Box is transformed from a three-dimensional box to a flat sheet

FIG. 8 View of the 1^{st} step of attachment of the Pop-up Box to the Base whereby the Slide Member of the Pop-up Box is inserted into the Base

FIG. 9 Overview from the perspective of an observer upon opening of the Card, at which time the Pop-up Box has been erected to form a three-dimensional box

### DETAILED DESCRIPTION OF THE INVENTION

The subject invention in its preferred embodiment can best be described by illustrating the fabrication, structural elements and characteristics as shown in the attached drawings.

The Card with Three Dimensional (3-D) Pop-Up Box consists of two main elements, the Base 10 and the 3-D Pop-up Box 20.

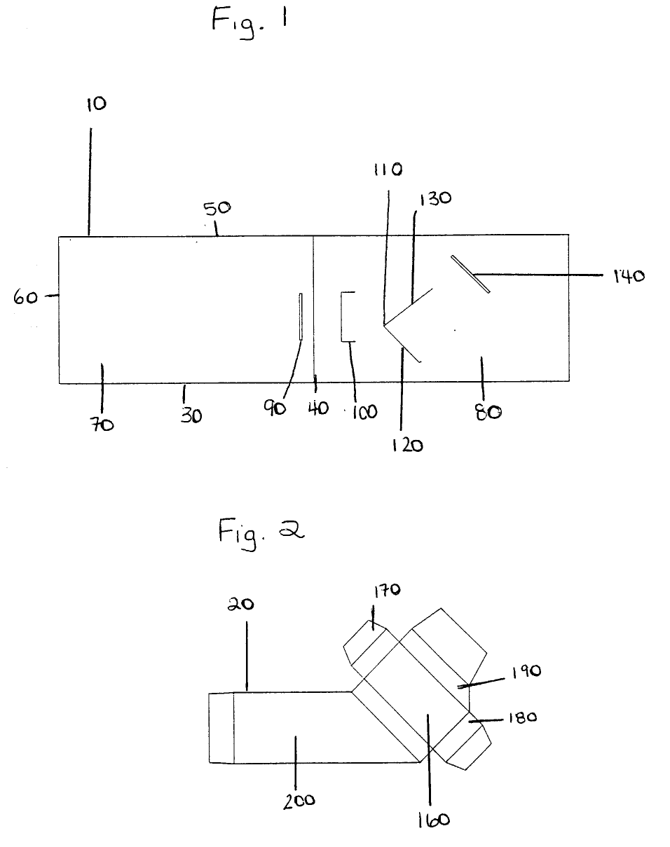

Referring to FIG. 1, the Base 10 is constructed from a sheet of paperboard or similar material which its folded along its horizontal axis 30 and then fastened along its top 50 and side 60 edges, forming an elongated pocket of half the height of the original sheet. This pocket is then folded once again on a vertical fold 40 placed equidistant from both side edges 60, thus creating a foldable Base 10 with right 80 and left 70 panels.

Referring to FIG. 1 it is apparent that this Base is perforated with four slits, as follows:

1 on the left panel 70 , a vertical slit 90 on the left side of the vertical fold 40 of the Base;

2 on the right panel 80, a vertical slit 100 on the right side of the vertical fold 40 and parallel to Slit 1 90;

3 an “L” shaped slit 110 consisting of a base 120 and a crown 130, set at an angle on the right panel 80 such that the point of the L is facing the left panel 70;

4 a slit 140 on the right panel 80, set an angle such that said slit 140 is parallel to the base 120 of the “L” of slit 3 110

Referring to FIG. 2, the Pop-up Box 20 (a single irregularly shaped piece of the same material as the Base 10), is comprised of:

1 a rectangular top (the “Box Top”) 160

2 a flap 170 at the top edges of the Box Top 160,

3 a flap 180 at the bottom edge of the Box Top 160,

4 a larger flap 190 at the outer side of the Box Top 160,

5 a Slide Member 200 which consists of a longer flap protruding from the inner edge of the Box Top 160.

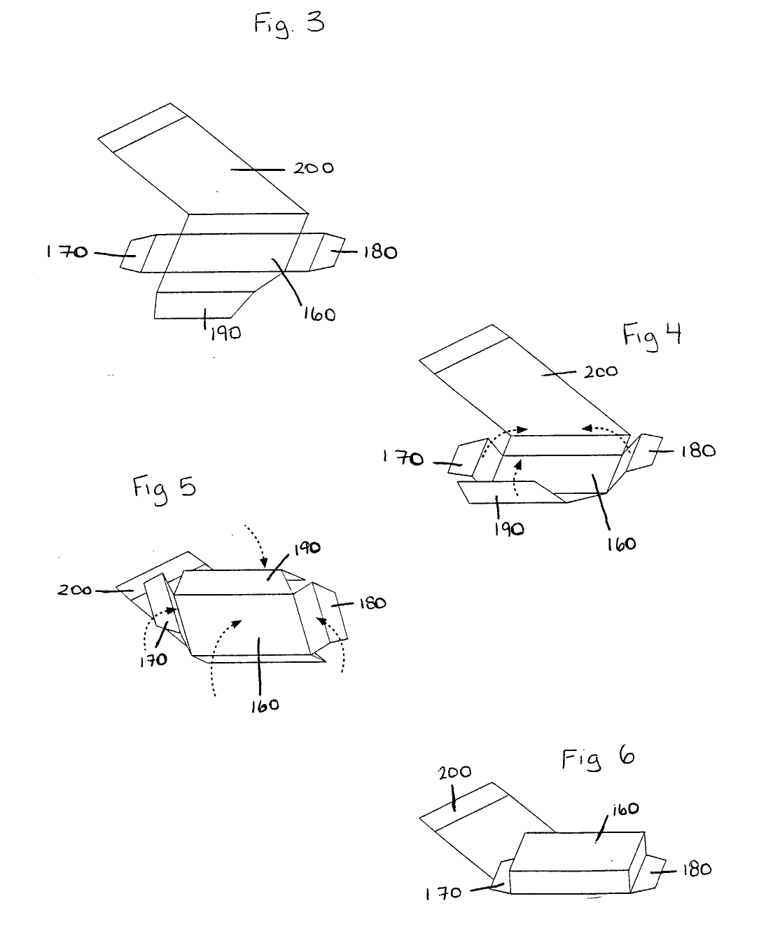

In FIGS. 3-6 is illustrated the process of assembly of the Pop-up Box 20 beginning with FIG. 3, the Pop-up Box 20 with its Box Top 160 and its flaps 170 180 190 200 of various shapes and dimensions before assembly.

FIG. 4 illustrates the first stages of the transformation of the Pop-up Box 20 from an irregularly shaped piece of paperboard into a three dimensional box. The top 170 and bottom 180 flaps must first be folded in a Z-shaped position, whereby the 1^{st} part of the flap which is attached to the Box Top 160 stands vertically at a 90 degree angle from the Box Top 160 and the 2^{nd} part of the flap is again folded at a 90 degree angle, thereby returning to a position parallel to the Box Top 160 but facing outwards. The larger flap 190 which is located on the outer side of the Box Top 160 is folded in a “C” shaped position with its first part standing vertically at a 90 degree angle from the Box Top 160, but with its second part being folded towards the inside of the Box Top 160 thus forming a base to the Box Top 160.

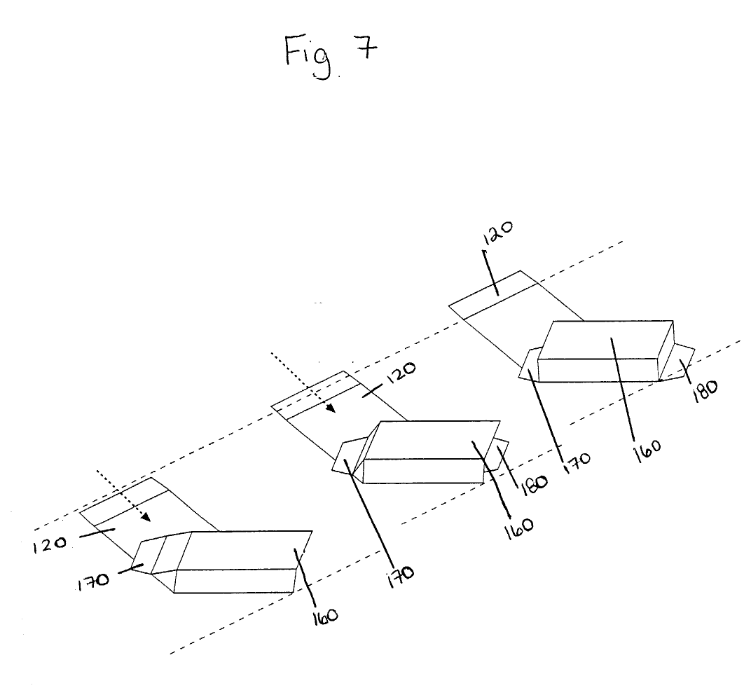

According to FIG. 5, the Box Top 160 with the 3 flaps 170 180 190 is then folded over the 4^{th} flap which constitutes the Slide Member 200, and the outer part of the 3^{rd} larger flap 190 is adhered to said Slide Member 200 by the use of an adhesive such as glue, securing the base of the Pop-up Box 20.

FIG. 6 illustrates the Pop-up Box 20 in its popped-up stage, before its attachment to the Base 10. Once the Pop-up Box 20 is assembled, folded and attached to the Base 10 it has the ability to lie flat or to pop-up into a 3-D box shaped object through the use of the Slide Member 200 being slid inside the envelope part of the Base 10.

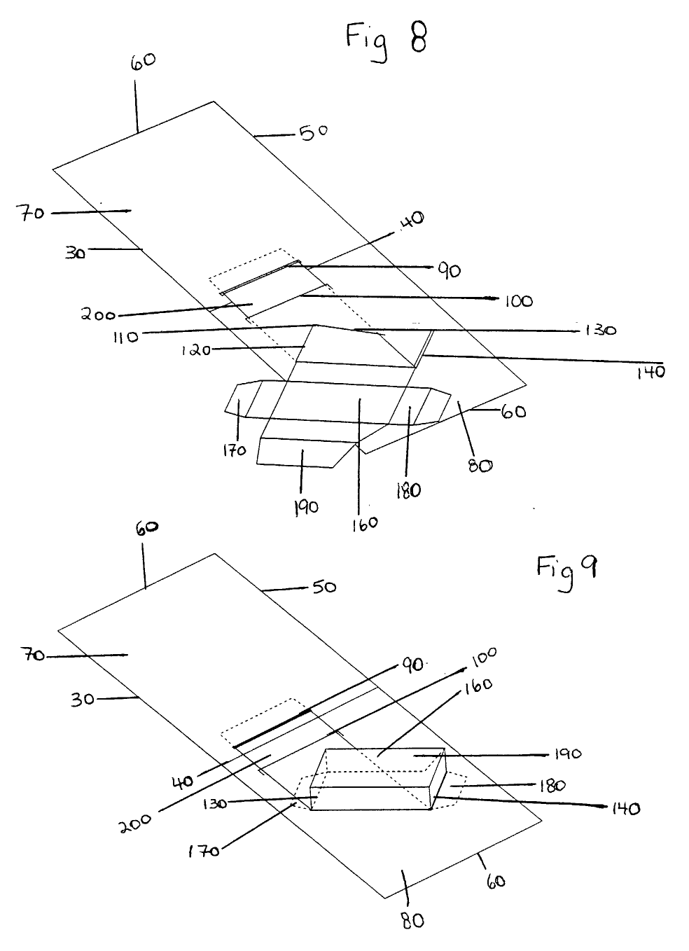

As is illustrated in FIG. 8, the Slide Member 200 is slipped into the pocket thru the 3^{rd} Slit 110, and then slipped out of the pocket through the 2^{nd} Slit 100 and reinserted into the pocket thru the 1^{st} Slit 90 where it is adhered to the inside of the pocket by the use of an adhesive such as glue. When the Base 10 and the Pop-up Box 20 are attached in this manner, the closing of the Base 10 along its vertical fold 40 pushes the Slide Member 200, as illustrated in FIG. 7, which movement causes the Pop-up Box 20 to “pop-down” from the shape of a 3-D box, formed by the Box Top 160, Flaps 1, 2 and 3 170 180 190 and the base of the Slide Member 200, into a folded sheet.

In FIG. 9 is illustrated an overview of the opened Card with 3-D Pop-up Box, whereby the 3-D Pop-up Box 20 has been erected into final position.

The fully assembled card can, by way of example, display words and images and can, by way of example, be used as an advertising or promotional device.

The present invention is not intended to be restricted to any particular form or arrangement, or any specific embodiment disclosed herein, or any specific use, since the same may be modified or varied substantially in various particulars or relations without departing from the spirit or scope of the claimed invention hereinabove shown and described, of which the apparatus shown is intended only for illustration and for disclosure of an operative embodiment and not to show all of the various forms or modifications in which the present invention might be embodied or operated.

That which is claimed is:

1. A Pop-up Card comprising a flat Base of foldable planar material and a Pop-up Device, wherein a three dimensional box is formed through the activation of the Pop-up Device.

2. The Pop-up Card of claim 1 wherein said Base is a formed of a piece of cardstock or other planar material.

3. The Pop-up Card of claim 2 wherein said base is rectangularly shaped

4. The Pop-up Card of claim 3 wherein said sheet is folded along its horizontal axis and sealed to form a pocket.

5. The Pop-up Card of claim 4 wherein said sheet is folded along its vertical fold to create a card that can be opened and closed.

6. The Pop-up Card of claim 5 wherein said base contains slits and openings of various dimensions and locations.

7. The Pop-up Card of claim 1, wherein Pop-up device is formed of a single piece of cardstock or other planar material.

8. The Pop-up Card of claim 1, wherein Pop-up device is irregularly shaped.

9. The Pop-up Card of claim 1, wherein Pop-up device comprises a rectangular box top, two flaps protruding from the top and bottom edges of said box top, a larger flap protruding from the outer edge of said box top and a slide member which is a longer flap protruding from the inner edge of the box top.

10. The Pop-up Card of claim 9, wherein said flaps are inserted into the various slits of the Base.

11. The Pop-up Card of claim 10, wherein said flaps are secured to the Base through the use of an adhesive.

12. The Pop-up Card of claim 1, wherein the motion of unfolding the Base, thus opening the card, causes a slide member to be pulled, thereby causing the Pop-up Device to pop-up.

13. The Pop-up Card of claim 12, wherein said Pop-up Device pops up in the shape of a three-dimensional box.

14. The Pop-up Card of claim 1, wherein the motion of folding the base, thus closing the card, causes the slide member to be retracted thereby causing the Pop-up device to flatten.

15. The Pop-up Card of claim 1, wherein the flat base and the pop-up device are laminated.

16. The Pop-up Card of claim 1, wherein the Base and/or the Pop-up Device display text, images or other forms of advertisement

17. A method of building a Pop-up Card comprising a flat base of foldable planar material and a pop-up device, wherein a three dimensional box is formed through the activation of the pop-up device.
